(19) United States
(12) Patent Application Publication
(10) Pub. No.: US 2018/0075360 A1
(43) Pub. Date: Mar. 15, 2018

(54) ACCURACY-ESTIMATING-MODEL GENERATING SYSTEM AND ACCURACY ESTIMATING SYSTEM

(71) Applicant: NEC CORPORATION, Tokyo (JP)

(72) Inventors: Akira TANIMOTO, Tokyo (JP); Junpei KOMIYAMA, Tokyo (JP); Yousuke MOTOHASHI, Tokyo (JP); Ryohei FUJIMAKI, Tokyo (JP); Yasuhiro SOGAWA, Tokyo (JP)

(21) Appl. No.: 15/560,085

(22) PCT Filed: Mar. 8, 2016
(86) PCT No.: PCT/JP2016/001253

§ 371 Date: Sep. 20, 2017

Related U.S. Application Data
(60) Provisional application No. 62/136,832, filed on Mar. 23, 2015.

(51) Int. Cl. G06N 5/04; G06N 99/00

(52) U.S. Cl. CPC G06N 5/048; G06N 99/005

(57) ABSTRACT

An accuracy estimation unit 91 estimates accuracy of a predictive model using an accuracy estimating model that is learned using, as an explanatory variable, all or part of one or more contexts each indicating a feature value representing an operation status of the predictive model at a first point of interest that is a past point in time of interest a learning period of the predictive model, and a parameter used to learn the predictive model and, as a response variable, an accuracy index in a period after the first point of interest. The accuracy estimation unit 91 calculates the context at a second point of interest that is a point in time after the first point of interest, and applies the calculated context to the accuracy estimating model to estimate the accuracy from the second point of interest onward.

### TECHNICAL FIELD

The present invention relates to an accuracy-estimating-model generating system, accuracy-estimating-model generating method, and accuracy-estimating-model generating program for generating an accuracy estimating model for estimating the accuracy of a predictive model, and to an accuracy estimating system, accuracy estimating method, and accuracy estimating program for estimating the accuracy of a predictive mode.

### BACKGROUND ART

Predictive models are known to degrade in prediction accuracy over time due to environmental changes and the like. Hence, a predictive model determined to improve in accuracy by updating is subjected to relearning, and updated with a predictive model generated as a result of the relearning as a new predictive model. For example, a predictive model with an increased difference between the actual value and the predicted value is selected and subjected to relearning.

Patent Literature (PTL) 1 describes an apparatus for predicting the energy demands of various facilities. The apparatus described in PTL 1 sequentially updates energy demand predictive models whenever a predetermined period has passed, using data acquired a day ago, data acquired an hour ago, or data acquired a minute ago.

### CITATION LIST

### Patent Literature

PTL 1: Japanese Patent Application Laid-Open No. 2012-194700

### SUMMARY OF INVENTION

### Technical Problem

However, a predictive model with an increased difference between the actual value and the predicted value does not necessarily keep degrading in prediction accuracy. For example, a predictive model with a temporarily increased difference between the actual value and the predicted value may not necessarily need to be updated. The method of determining the update target based simply on the difference between the actual value and the predicted value has a technical problem of subjecting a predictive model that has not actually degraded to updating.

Besides, even though a predictive model generated as a result of relearning is temporarily capable of high-accuracy prediction, whether or not its accuracy is maintained is unclear. In view of the costs associated with updating the predictive model again in the case where the predictive model generated as a result of relearning has severe accuracy degradation, it is not always preferable to update the predictive model with the relearned predictive model.

Typically, updating a predictive model requires resources and costs. Hence, the method of updating a predictive model regardless of accuracy degradation as in the apparatus described in PTL 1 has a technical problem of increasing the load on the operator in actual operation.

The present invention accordingly has an object of providing an accuracy-estimating-model generating system, accuracy-estimating-model generating method, and accuracy-estimating-model generating program that can generate an accuracy estimating model for appropriately estimating the accuracy of a predictive model, and an accuracy estimating system, accuracy estimating method, and accuracy estimating program that can appropriately estimate the accuracy of a predictive model.

### Solution to Problem

An accuracy-estimating-model generating system according to the present invention includes: a context calculation unit which calculates, for each predictive model learned using data in a set learning period, a feature value representing an operation status of the predictive model at a first point of interest that is a past point in time of interest, as a context; an accuracy index calculation unit which calculates an accuracy index of the predictive model, using time series data of an error index in a period alter the first point of interest; a data set generation unit which generates a data set in which all or part of the learning period, a parameter used to learn the predictive model, and the context is an explanatory variable and the accuracy index is a response variable; and a model generation unit which generates an accuracy estimating model for estimating accuracy of the predictive model, using the generated data set as learning data.

An accuracy estimating system according to the present invention includes an accuracy estimation unit which estimates accuracy of a predictive model using an accuracy estimating model that is learned using, as an explanatory variable, all or part of one or more contexts each indicating a feature value representing an operation status of the predictive model at a first point of interest that is a past point in time of interest, a learning period of the predictive model, and a parameter used to learn the predictive model and, as a response variable, an accuracy index in a period after the first point of interest, wherein the accuracy estimation unit calculates the context at a second point of interest that is a point in time after the first point of interest, and applies the calculated context to the accuracy estimating model to estimate the accuracy from the second point of interest onward.

An accuracy-estimating-model generating method according to the present invention includes: calculating, for each predictive model learned using data in a set learning period, a feature value representing an operation status of the predictive modes at a first point of interest that is a past point in time of interest, as a context; calculating an accuracy index of the predictive model, using time series data of an error index in a period after the first point of interest; generating a data set in which all or part of the learning period, a parameter used to learn the predictive model, and the context is an explanatory variable and the accuracy index is a response variable; and generating an accuracy estimating model for estimating accuracy of the predictive model, using the generated data set as learning data.

An accuracy estimating method according to the present invention includes estimating accuracy of a predictive model using an accuracy estimating model that is learned using, as an explanatory variable, all or part of one or more contexts each indicating a feature value representing an operation status of the predictive model at a first point of interest that is a past point in time of interest, a learning period of the predictive model, and a parameter used to learn the predictive model and, as a response variable, an accuracy index in a period after the first point of interest, wherein in the estimation of the accuracy, the context at a second point of interest that is a point in time after the first point of interest is calculated, and the calculated context is applied to the accuracy estimating model to estimate the accuracy from the second point of interest onward.

An accuracy-estimating-model generating program according to the present invention causes a computer to execute: a context calculation process of calculating, for each predictive model learned using data in a set learning period, a feature value representing an operation status of the predictive model at a first point of interest that is a past point in time of interest as a context; an accuracy index calculation process of calculating an accuracy index of the predictive model, using time series data of an error index in a period after the first point of interest; a data set generation process of generating a data set in which all or part of the learning period, a parameter used to learn the predictive model, and the context is an explanatory variable and the accuracy index is a response variable; and a model generation process of generating an accuracy estimating model for estimating accuracy of the predictive model, using the generated data set as learning data.

An accuracy estimating program according to the present invention causes a computer to execute an accuracy estimation process of estimating accuracy of a predictive model using an accuracy estimating model that is learned using, as an explanatory variable, all or part of one or snore contexts each indicating a feature value representing an operation status of the predictive model at a first point of interest that is a past point in time of interest, a learning period of the predictive model, and a parameter used to learn the predictive model and, as a response variable, an accuracy index in a period after the first point of interest, wherein in the accuracy estimation process, the computer is caused to calculate the context at a second point of interest that is a point in time after the first point of interest, and apply the calculated context to the accuracy estimating model to estimate the accuracy from the second point of interest onward.

### Advantageous Effects of Invention

According to the present invention, the technical means described above achieve a technical advantageous effect of appropriately estimating the accuracy of a predictive model.

### BRIEF DESCRIPTION OF DRAWINGS

FIG. 1 is a block diagram depicting an exemplary embodiment of a model operation system according to present invention.

FIG. 2 is an explanatory diagram depicting an example of displaying accuracy status.

FIG. 3 is an explanatory diagram depicting another example of displaying accuracy status.

FIG. 4 is a flowchart depicting an example of operation of generating an accuracy estimating model.

FIG. 5 is a flowchart depicting an example of operation of estimating accuracy degradation and determining whether or not to update a predictive model.

FIG. 6 is a block diagram schematically depicting an accuracy-estimating-model generating system according to the present invention.

FIG. 7 is a block diagram schematically depicting an accuracy estimating system according to the present invention.

### DESCRIPTION OF EMBODIMENT

The following describes an exemplary embodiment of the present invention with reference to drawings.

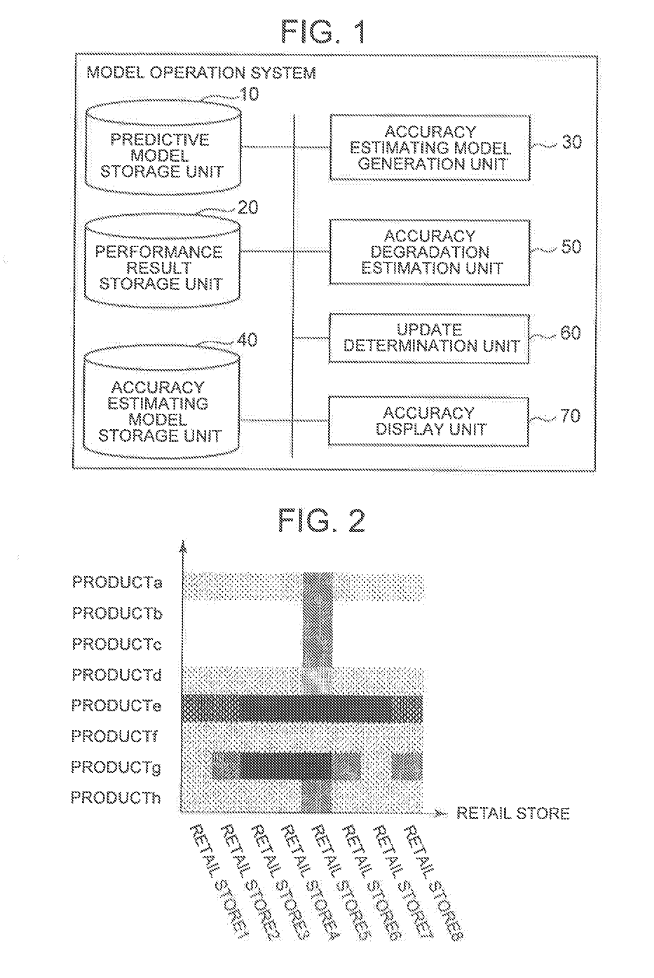

FIG. 1 is a block diagram depicting an exemplary embodiment of a model operation system according to the present invention. A model operation system in this exemplary embodiment includes a predictive model storage unit 10, a performance result storage unit 20, an accuracy estimating model generation unit 30, an accuracy estimating model storage unit 40, an accuracy degradation estimation unit 50, an update determination unit 60, and an accuracy display unit 70.

The predictive model storage unit 10 stores each combination of a period (hereafter referred to as “learning period”) of data used to learn a predictive model and parameters (hereafter referred to as “various learning engine parameters”) used to learn the predictive model. The predictive model storage unit 10 may store, in association with the combination, the predictive model learned based on the learning period and the various learning engine parameters. This exemplary embodiment assumes that the predictive model learned in this way is also stored in the predictive model storage unit 10.

The learning period and the various learning engine parameters may be selected by any method. The learning period is, for example, set in units of one month (January, February, . . . , December), three months (January to March, February to April, . . . , October to December), six months (January to June, . . . , July to December), or the like. Regarding the various learning engine parameters, too, a plurality of types of parameters are set from a predetermined perspective. Combining the set learning period and various learning engine parameters enables the generation of the predictive model based on the various learning engine parameters using data in the learning period.

The performance result storage unit 20 stores the prediction result by each predictive model of the predictive model group stored in the predictive model storage unit 10, in a time series. The prediction result is stored in the performance result storage unit 20 by the below-mentioned accuracy estimating model generation unit 30. The performance result storage unit 20 may store the below-mentioned data set.

The accuracy estimating model generation unit 30 acquires the result, in a time series, of associating the prediction result by each predictive model of the predictive model group stored in the predictive model storage unit 10 with the actual result acquired in actual operation, and stores the acquired result in the performance result storage unit 20 as time series data. The accuracy estimating model generation unit 30 also calculates an error index based on the prediction result and the actual result in a time series, and stores the error index in the performance result storage unit 20.

The error index may have any contents and may be calculated by any method, as long as it is an index calculated using the prediction result and the actual result. For example, the accuracy estimating model generation unit 30 may calculate the absolute difference between the prediction result and the actual result or the average absolute error rate in a predetermined period, as the error index. The average absolute error rate may be calculated by Σ|y-z|/Σ|z|, for prediction result y and actual result z in a given period (e.g. one month). The error index calculated is not limited to the above. Moreover, the number of types of error indexes calculated is not limited to one, and may be two or more.

The accuracy estimating model generation unit 30 then calculates a feature value (hereafter referred to as “context”) representing the operation status of each predictive model. In detail, the accuracy estimating model generation unit 30 calculates, for each predictive model learned using data in the set period (learning period), a feature value representing the operation status of the predictive model at a past point in time of interest, as a context. The past point in time of interest is hereafter referred to as “past update try time”.

The contents and type of the context are not limited as long as it is a feature value representing the operation status of the predictive model. Examples include the accuracy change status of the predictive model, the period from when learning the predictive model, the similarity to the time of learning the predictive model, and the maximum error in the operation period. The context may be expressed by a multidimensional vector having these feature values as elements.

The accuracy estimating model generation unit 30 calculates the context associated with the learning period and the past update try time using, from among the time series data of the error index and an index related to date and time, at least one of the time series data and the index up to the past update try time. The index related to date and time is an index indicating the temporal relevance to the learning period. Examples of the index include time of day, period, and season.

For example, the accuracy estimating model generation unit 30 may generate the context by combining the number of days passed from the average date and time of the learning period to the past update try time, the difference (%) between the average absolute error rate of two months immediately after the learning and the average absolute error rate of the most recent one month, and a maximum error sample.

The context calculated in this way not only represents the operation status, but also is a feature value for determining how much improvement is achieved in the case of relearning and updating the predictive model in what kind of status as compared with in the case of not updating the predictive model. The context can be regarded as an element expressing the “degree of need for relearning”. The past update try time is a requirement for calculating the context, and may be selected by any method as long as it is an appropriate timing for calculating the above-mentioned feature value.

The accuracy estimating model generation unit 30 then calculates an accuracy index of the predictive model, using the error index in a period after the past update try time. The period of the error index used for the calculation is hereafter referred to as “optimization target period”. The end of the optimization target period may or may not be set. For example, the accuracy estimating model generation unit 30 may calculate the accuracy index using the whole error index after the update try time, or calculate the accuracy index using the error index in a predetermined period (e.g. three months). The optimization target period is substantially a period up to the next update of the predictive model.

As a result of these processes, a set of combinations each made up of {learning period, various learning engine parameters, past update try time, context optimization target period, accuracy index} is generated. The accuracy estimating model generation unit 30 generates a data set in which ail or part of the learning period, various learning engine parameters, and context is an explanatory variable and the accuracy index is a response variable, from among the information included in the combination. The accuracy estimating model generation unit 30 stores the generated data set in the performance result storage unit 20.

The accuracy estimating model generation unit 30 then generates, using the generated data set as learning data, an accuracy estimating model for predicting accuracy degradation, by machine learning as an example. The method of generating the accuracy estimating model is not limited to a specific method, and may be any commonly known method. The accuracy estimating model generation unit 30 stores the generated accuracy estimating model in the accuracy estimating model storage unit 40.

The accuracy estimating model storage unit 40 stores the accuracy estimating model. The accuracy estimating model storage unit 40 may store the accuracy estimating model generated by the accuracy estimating model generation unit 30, or store the accuracy estimating model generated by another apparatus or system or the accuracy estimating model generated by the user or the like.

The accuracy degradation estimation unit 50 sets a point in time (hereafter referred to as “present update try time”) when determining the accuracy of the predictive model subjected to the determination, and an optimization target period. The present update try time is the time corresponding to the past update try time in the accuracy estimating model, and is set to be a time after the past update try time.

The optimization target period is preferably set to coincide with the period of the error index used to calculate the accuracy index by the accuracy estimating model generation unit 30. For example, in the case where the period of the error index used to calculate the accuracy index is three months, the accuracy degradation estimation unit 50 may set the optimization target period to three months.

The end of the optimization target period may or may not be set as in the case where the accuracy estimating model generation unit 30 determines the optimization target period. For example, in the case where the period until the next model replacement is the optimization target period, the accuracy degradation estimation unit 50 need not explicitly set the optimization target period.

The accuracy degradation estimation unit 50 calculates the context of the predictive model subjected to the accuracy degradation estimation (specifically, the predictive model currently in operation) at the present update try time. The method of calculating the context is the same as the method of calculating the context by the accuracy estimating model generation unit 30.

The accuracy degradation estimation unit 50 applies the calculated context to the accuracy estimating model, to calculate the accuracy index of the predictive model subjected to the accuracy degradation estimation (specifically, the predictive model currently in operation) in the optimization target period. Since there is a possibility that all past data are stored in the accuracy estimating model storage unit, the accuracy degradation estimation unit 50 may, for example, extract past data similar to the calculated context (e.g. close in Euclidean distance) and set the average accuracy index as the eventual accuracy index.

The update determination unit 60 determines whether or not to relearn the predictive model. The determination may be performed by any method. For example, the update determination unit 60 may determine to relearn the predictive model, in the case where the calculated accuracy index does not meet a predetermined accuracy index requirement.

The update determination unit 60 then relearns the target predictive model. First, the update determination unit 60 determines a learning period and various learning engine parameters used in the relearning, based on a predetermined method.

For example, the update determination unit 60 may determine the learning period and the various learning engine parameters by the same method as the selection method upon storing in the predictive model storage unit 10. The update determination unit 60 may select one or snore combinations of learning period and various learning engine parameters determined as corresponding to high performance in the processes up to the process by the accuracy degradation estimation unit 50. The update determination unit 60 may determine the learning period and the various learning engine parameters using any method other than the above.

The update determination unit 60 relearns the predictive model, using the determined learning period and various learning engine parameters. The update determination unit 60 may relearn the predictive model by the same method as the previous learning method. The update determination unit 60 may relearn the predictive model so that the relearned predictive model is close to the original predictive model.

The update determination unit 60 also calculates the context of the relearned predictive model at the present update try time. The update determination unit 60 then calculates the accuracy index of the relearned predictive model in the optimization target period, based on the accuracy estimating model. The method of calculating the accuracy index is the same as the method of calculating the accuracy index by the accuracy degradation estimation unit 50.

The update determination unit 60 determines whether or not to update the original predictive model with the relearned predictive model. The update determination is performed using all or part of the accuracy index and context of the original predictive model calculated by the accuracy degradation estimation unit 50, the accuracy index and context of the relearned predictive model calculated by the update determination unit 60, the predictive model itself and the prediction result. Using these information, the update determination unit 60 determines whether or not to update the predictive model, based on a predetermined method.

For example, the update determination unit 60 may calculate the error index in a validation period, and determine whether or not to update the predictive model depending on whether or not the calculated error index meets a predetermined requirement for updating. The validation period is typically set to the most recent several weeks or the like, and does not overlap the learning period.

Alternatively, the update determination unit 60 may determine whether or not to update the predictive model depending on the closeness between the original predictive model and the relearned predictive model. The closeness between the two predictive models is determined using, for example, the degree of coincidence in variables used in the predictive model, the similarity in conditional branching in the predictive model, the similarity in coefficients in the predictive model, the closeness in prediction result calculated from the predictive model, or the like.

In the case where a plurality of relearned predictive models are generated, the update determination unit 60 may determine which of the generated predictive models is used to update the original predictive model. For example, the update determination unit 60 may more preferentially select a predictive model close to the original predictive model (model in operation), or more preferentially select a predictive model with a small maximum error in the validation period.

The update determination unit 60 then updates the original predictive model stored in the predictive model storage unit 10, with the relearned predictive model.

The accuracy display unit 70 displays the accuracy status of each predictive model. In detail, the accuracy display unit 70 visualizes information specified by at least one of the accuracy of the predictive model before updating and the accuracy of the predictive model after updating. For example, the accuracy display unit 70 may visualize the changes of the accuracy index of each predictive model, or visualize the accuracy index of each predictive model estimated by the accuracy degradation estimation unit 50. The accuracy display unit 70 may visualize, with respect to the accuracy index of each predictive model estimated by the accuracy degradation estimation unit 50, the change (hereafter referred to as “accuracy improvement degree”) of the accuracy index of the predictive model relearned by the update determination unit 60. Thus, the accuracy display unit 70 may display information specified by the accuracy estimated by the accuracy estimating model.

FIG. 2 is an explanatory diagram depicting an example of displaying accuracy status. FIG. 2 depicts an example where the accuracy index of the sales predictive model generated for each product of each retail store is represented in a heat map. In the example in FIG. 2, the horizontal axis represents each retail store, and the vertical axis represents each product, with the accuracy index of the sales predictive model being expressed by the darkness of shading at the position of the corresponding coordinates. The accuracy display unit 70 may display a heat map using the above-mentioned accuracy improvement degree instead of the accuracy index.

Although FIG. 2 depicts a two-dimensional heat map, the number of dimensions of the heat map is not limited to two, and may be three. Moreover, any attribute that enables the classification of the predictive model may be set in each axis of the heat map. The accuracy display unit 70 may receive an instruction to rearrange the attributes set in each axis according to their property. For example, in the case where each retail store is set in an axis as an attribute, the accuracy display unit 70 may receive an instruction indicating retail store region, retail store type, retail store size, demographic index, or the like, and rearrange the retail stores based on the instruction. With such a structure, relevant attributes can be summarized to thus facilitate the recognition of their accuracy statuses at a glance.

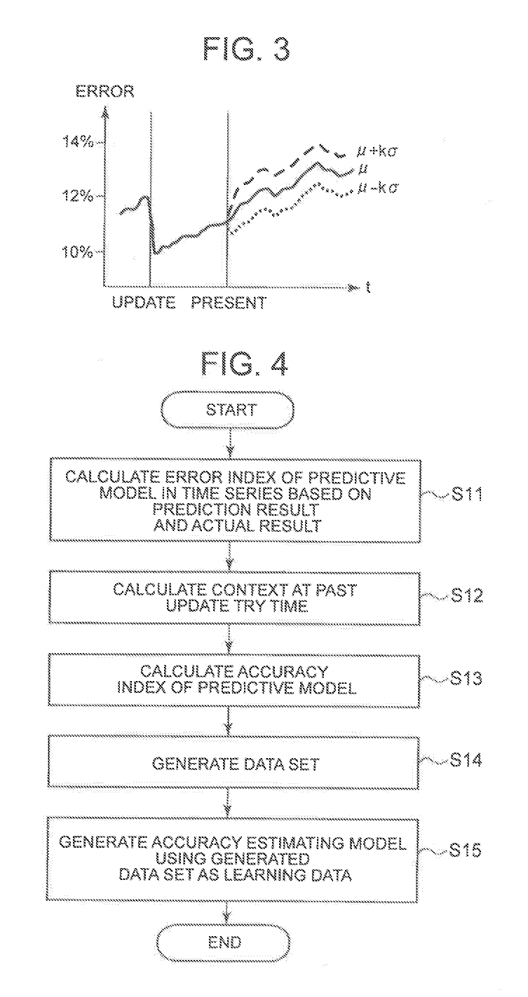

FIG. 3 is an explanatory diagram depicting another example of displaying accuracy status. FIG. 3 depicts an example where the changes of the accuracy index of a model are represented in a line graph. In the example in FIG. 3, the changes of the accuracy index up to the present are represented in a line graph. In addition, for the future accuracy index, the changes of each of a plurality of accuracy indexes estimated are represented in a line graph. In FIG. 3, μ denotes an estimation average, a denotes an estimation variance, and k denotes a given positive number.

The accuracy display unit 70 may display the changes of each of the plurality of accuracy indexes on one screen. The accuracy display unit 70 may selectively display the changes of the corresponding accuracy index from among the plurality of accuracy indexes, in response to an instruction from the user (e.g. an instruction indicating the value of k, the case of over-estimation, the case of under-estimation, etc.).

Moreover, the accuracy display unit 70 may quote a predictive model having a similar context from past data, and display the time series variation of the accuracy of the predictive model and the error index of the predictive model in the optimization target period.

The accuracy estimating model generation unit 30 is realized by a CPU in a computer operating according to a program (accuracy-estimating-model generating program). The accuracy degradation estimation unit 50, the update determination unit 60, and the accuracy display unit 70 are realized by a CPU in a computer operating according to a program (accuracy estimating program). These programs may be combined into one program, or may be separate programs.

For example, each program may be stored in a storage unit (not depicted) in the model operation system, with the CPU reading the program and, according to the program, operating as the accuracy estimating model generation unit 30. the accuracy degradation estimation unit 50, the update determination unit 60, and the accuracy display unit 70. Alternatively, the control unit 1a, the accuracy estimating model generation unit 30, the accuracy degradation estimation unit 50, the update determination unit 60, and the accuracy display unit 70 may each be realized by dedicated hardware.

The accuracy estimating model generation unit 30, the accuracy degradation estimation unit 50, the update determination unit 60, and the accuracy display unit 70 may each be realized by dedicated hardware. The predictive model storage unit 10, the performance result storage unit 20, and the accuracy estimating model storage unit 40 are, for example, realized by a magnetic disk device or the like. The model operation system according to the present invention may be composed of two or more physically separate apparatuses that are wiredly or wirelessly connected to each other.

The following describes the operation of the model operation system in this exemplary embodiment. The operation of the accuracy estimating model generation unit 30 generating an accuracy estimating model is described first. FIG. 4 is a flowchart depicting an example of the operation of generating an accuracy estimating model.

First, the accuracy estimating model generation unit 30 calculates the error index of a predictive model in a time series based on the prediction result and the actual result, and stores the error index in the performance result storage unit 20 (step S11). The accuracy estimating model generation unit 30 then calculates the context at the past update try time (step S12). The accuracy estimating model generation unit 30 also calculates the accuracy index of the predictive model, using the error index in the period after the past update try time (step S13).

The accuracy estimating model generation unit 30 generates a data set in which all or part of the learning period, various learning engine parameters, and context is an explanatory variable and the accuracy index is a response variable (step S14). The accuracy estimating model generation unit 30 then generates an accuracy estimating model for predicting accuracy degradation, using the generated data set as learning data (step S15).

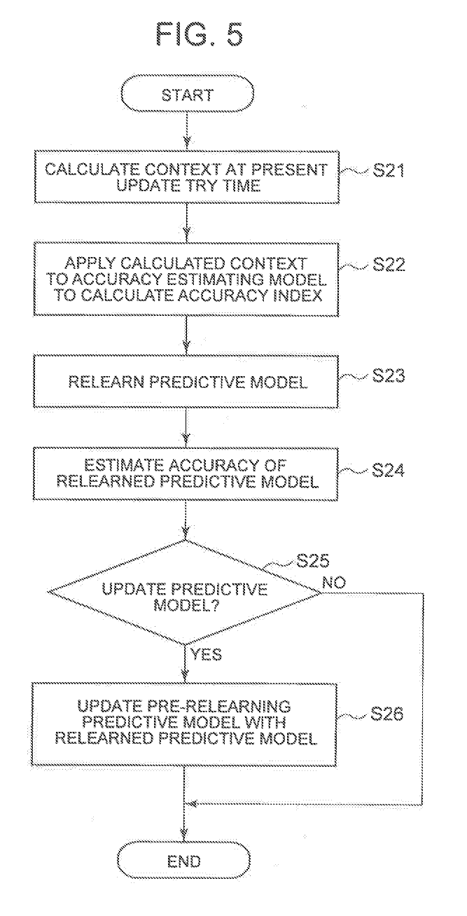

The operation of the accuracy degradation estimation unit 50 estimating the accuracy of a predictive model and the operation of the update determination unit 60 determining whether or not to update the predictive model are described next. FIG. 5 is a flowchart depicting an example of the operation of estimating accuracy degradation and determining whether or not to update a predictive model.

The accuracy degradation estimation unit 50 calculates the context of a predictive model subjected to accuracy degradation estimation at the present update try time (step S21). The accuracy degradation estimation unit 50 applies the calculated context to the accuracy estimating model, to calculate the accuracy index of the predictive model subjected to accuracy degradation estimation in the optimization target period (step S22).

The update determination unit 60 relearns the predictive model (step S23).

The update determination unit 60 then estimates the accuracy of the relearned predictive model using the accuracy estimating model (step S24). The update determination unit 60 determines whether or not to update the pre-relearning predictive model with the relearned predictive model, by at least comparing the accuracy of the pre-relearning predictive model and the accuracy of the relearned predictive model (step S25).

In the case of determining to update the pre-relearning predictive model (step S25: Yes), the update determination unit 60 updates the pre-relearning predictive model with the relearned predictive model (step S26). In the case of determining not to update the pre-relearning predictive model (step S25: No), the update determination unit 60 does not update the predictive model.

As described above, in this exemplary embodiment, the accuracy estimating model generation unit 30 calculates, for each predictive model learned using data in the set learning period, the context at the past update try time, and calculates the accuracy index of the predictive model using the time series data of the error index in the optimization target period. The accuracy estimating model generation unit 30 also generates a data set in which all or part of the learning period, various learning engine parameters, and context is an explanatory variable and the accuracy index is a response variable, and generates an accuracy estimating model using the generated data set as learning data. An accuracy estimating model for appropriately estimating the accuracy of a predictive model can thus be generated.

Moreover, in this exemplary embodiment, the accuracy degradation estimation unit 50 estimates the accuracy of the predictive model, using the accuracy estimating model learned using ail or part of one or more contexts, learning period of the predictive model, and various learning engine parameters as an explanatory variable and the accuracy index in the optimization target period as a response variable. In detail, the accuracy degradation estimation unit 50 calculates the context at the present update try time, and applies the calculated context to the accuracy estimating model to estimate subsequent accuracy. The accuracy of a predictive model can thus be estimated appropriately.

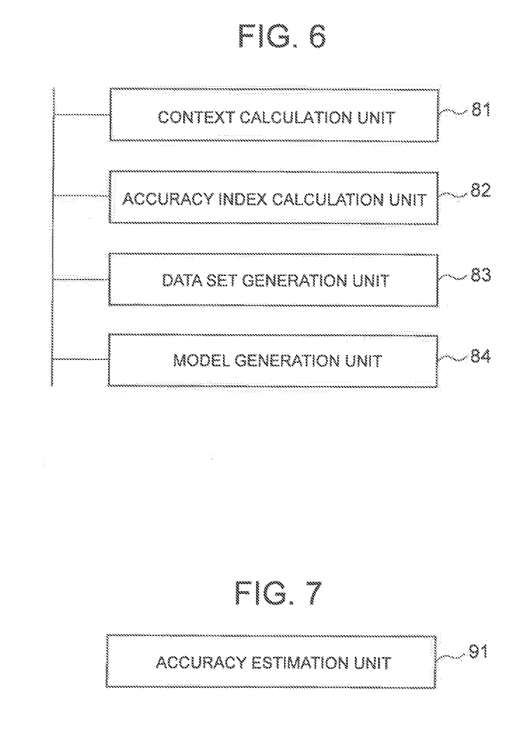

The following describes an overview of the present invention. FIG. 6 is a block diagram schematically depicting an accuracy-estimating-model generating system according to the present invention. An accuracy-estimating-model generating system according to the present invention includes: a context calculation unit 81 (e.g. the accuracy estimating model generation unit 30) which calculates, for each predictive model learned using data in a set learning period, a feature value representing an operation status of the predictive model at a first point of interest (e.g. past update try time) that is a past point in time of interest, as a context; an accuracy index calculation unit 82 (e.g. the accuracy estimating model generation unit 30) which calculates an accuracy index of the predictive model, using time series data of an error index in a period (e.g. optimization target period) after the first point of interest; a data set generation unit 83 (e.g. the accuracy estimating model generation unit 30) which generates a data set in which all or part of the learning period, a parameter (e.g. various learning engine parameters) used to learn the predictive model, and the context is an explanatory variable and the accuracy index is a response variable; and a model generation unit 84 (e.g. the accuracy estimating model generation unit 30) which generates an accuracy estimating model for estimating accuracy of the predictive model, using the generated data set as learning data.

With such a structure, an accuracy estimating model for appropriately estimating the accuracy of a predictive model can be generated.

The context calculation unit 81 may calculate the context associated with the learning period and the first point of interest using, from among time series data of the error index and an index (e.g. time of day, period, season, etc.) related to date and time, at least one of the time series data and the index up to the first point of interest.

The accuracy-estimating-model generating system may include an error index calculation unit (e.g. the accuracy estimating model generation unit 30) which calculates the error index of the predictive model based on a prediction result by the predictive model and an actual result, in a time series. The accuracy index calculation unit 82 may calculate the accuracy index of the predictive model using the calculated error index.

FIG. 7 is a block diagram schematically depicting an accuracy estimating system according to the present invention. An accuracy estimating system according to the present invention includes an accuracy estimation unit 91 (e.g. the accuracy degradation estimation unit 50) which estimates accuracy of a predictive model using an accuracy estimating model that is learned using, as an explanatory variable, all or part of one or more contexts each indicating a feature value representing an operation status of the predictive model at a first point of interest (e.g. past update try time) that is a past point in time of interest, a learning period of the predictive model, and a parameter (e.g. various learning engine parameters) used to learn the predictive model and, as a response variable, an accuracy index in a period (e.g. optimization target period) after the first point of interest.

The accuracy estimation unit 91 calculates the context at a second point of interest (e.g. present update try time) that is a point in time after the first point of interest, and applies the calculated context to the accuracy estimating model to estimate the accuracy from the second point of interest onward. With such a structure, the accuracy of a predictive model can be estimated appropriately.

The context may be calculated using, from among time series data of an error index calculated based on a prediction result by the predictive model and an actual result and an index (e.g. time of day, period, season, etc.) related to date and time, at least one of the time series data and the index up to the first point of interest, and associated with the learning period of the predictive model and the first point of interest.

The accuracy estimating system may include an update determination unit (e.g. the update determination unit 60) which determines whether or not to update the predictive model whose accuracy is estimated. The update determination unit may relearn the predictive model estimate the accuracy of the relearned predictive model using the accuracy estimating model, and determine whether or not to update a pre-relearning predictive model that is the predictive model before the relearning with the relearned predictive model by at least comparing the accuracy of the pre-relearning predictive model and the accuracy of the relearned predictive model.

The accuracy estimating system may include an accuracy display unit (e.g. the accuracy display unit 70) which displays an accuracy status of each predictive model. The accuracy display unit may display information specified by at least one of the accuracy of the predictive model before updating and the accuracy of the predictive model after the updating.

The accuracy display unit may display information specified by the accuracy estimated using the accuracy estimating model.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

This application claims priority based on U.S. Provisional Patent Application No. 62/136,832 filed on Mar. 23, 2015, the disclosure of which is incorporated herein in its entirety.

### REFERENCE SIGNS LIST

10 predictive model storage unit

20 performance result storage unit

30 accuracy estimating model generation unit

40 accuracy estimating model storage unit

50 accuracy degradation estimation unit

60 update determination unit

70 accuracy display unit

1. An accuracy-estimating-model generating system comprising:
a context calculation unit which calculates, for each predictive model learned using data in a set learning period, a feature value representing an operation status of the predictive model at a first point of interest that is a past point in time of interest, as a context;
an accuracy index calculation unit which calculates an accuracy index of the predictive model, using time series data of an error index in a period after the first point of interest;
a data set generation unit which generates a data set in which all or part of the learning period, a parameter used to learn the predictive model, and the context is art explanatory variable and the accuracy index is a response variable; and
a model generation unit which generates an accuracy estimating model for estimating accuracy of the predictive model, using the generated data set as learning data.

2. The accuracy-estimating-model generating system according to claim 1, wherein the context calculation unit calculates the context associated with the learning period and the first point of interest using, from among time series data of the error index and an index related to date and time, at least one of the time series data and the index up to the first point of interest.

3. The accuracy-estimating-model generating system according to claim 1 or 2, comprising
an error index calculation unit which calculates the error index of the predictive model based on a prediction result by the predictive model and an actual result, in a time series,
wherein the accuracy index calculation unit calculates the accuracy index of the predictive model using the calculated error index.

4. An accuracy estimating system comprising
an accuracy estimation unit which estimates accuracy of a predictive model using an accuracy estimating model that is learned using, as an explanatory variable, all or part of one or more contexts each indicating a feature value representing an operation status of the predictive model at a first point of interest that is a past point in time of interest, a learning period of the predictive model, and a parameter used to learn the predictive model and, as a response variable, an accuracy index in a period after the first point of interest,
wherein the accuracy estimation unit calculates the context at a second point of interest that is a point in time after the first point of interest, and applies the calculated context to the accuracy estimating model to estimate the accuracy from the second point of interest onward.

5. The accuracy estimating system according to claim 4, wherein the context is calculated using, from among time series data of an error index calculated based on a prediction result by the predictive model and an actual result and an index related to date and time, at least one of the time series data and the index up to the first point of interest, and is associated with the learning period of the predictive model and the first point of interest.

6. The accuracy estimating system according to claim 4 or 5, comprising
an update determination unit which determines whether or not to update the predictive model whose accuracy is estimated,
wherein the update determination unit relearns the predictive model, estimates the accuracy of the relearned predictive model using the accuracy estimating model, and determines whether or not to update a pre-relearning predictive model that is the predictive model before the relearning with the relearned predictive model by at least comparing the accuracy of the pre-relearning predictive model and the accuracy of the relearned predictive model.

7. The predictive model accuracy estimating apparatus according to any one of claims 4 to 6, comprising
an accuracy display unit which displays an accuracy status of each predictive model,
wherein the accuracy display unit displays information specified by at least one of the accuracy of the predictive model before updating and the accuracy of the predictive model after the updating.

8. The accuracy estimating system according to claim 7, wherein the accuracy display unit displays information specified by the accuracy estimated using the accuracy estimating model.

9. An accuracy-estimating-model generating method comprising:
calculating, for each predictive model learned using data in a set learning period, a feature value representing an operation status of the predictive model at a first point of interest that is a past point in time of interest, as a context;
calculating an accuracy index of the predictive model, using time series data of an error index in a period after the first point of interest;
generating a data set in which all or part of the learning period, a parameter used to learn the predictive model, and the context is an explanatory variable and the accuracy index is a response variable; and
generating an accuracy estimating model for estimating accuracy of the predictive model, using the generated data set as learning data.

10. The accuracy-estimating-model generating method according to claim 9, wherein the context associated with the learning period and the first point of interest is calculated using, from among time series data of the error index and an index related to date and time, at least one of the time series data and the index up to the first point of interest.

11. An accuracy estimating method comprising
estimating accuracy of a predictive model using an accuracy estimating model that is learned using, as an explanatory variable, all or part of one or more contexts each indicating a feature value representing an operation status of the predictive model at a first point of interest that is a past point in time of interest, a learning period of the predictive model, and a parameter used to learn the predictive model and, as a response variable, an accuracy index in a period after the first point of interest.
wherein in the estimation of the accuracy, the context at a second point of interest that is a point in time after the first point of interest is calculated, and the calculated context is applied to the accuracy estimating model to estimate the accuracy from the second point of interest onward.

12. The accuracy estimating method according to claim 11, wherein the context is calculated using, from among time series data of an error index calculated based on a prediction result by the predictive model and an actual result and an index related to date and time, at least one of the time series data and the index up to the first point of interest, and is associated with the learning period of the predictive model and the first point of interest.

13. An accuracy-estimating-model generating program for causing a computer to execute:
a context calculation process of calculating, for each predictive model learned using data in a set learning period, a feature value representing an operation status of the predictive model at a first point of interest that is a past point in time of interest, as a context;
an accuracy index calculation process of calculating an accuracy index of the predictive model, using time series data of an error index in a period after the first point of interest;
a data set generation process of generating a data set in which all or part of the learning period, a parameter used to learn the predictive model and the context is an explanatory variable and the accuracy index is a response variable; and
a model generation process of generating an accuracy estimating model for estimating accuracy of the predictive model, using the generated data set as learning data.

14. The accuracy-estimating-model generating program according to claim 13, wherein in the context calculation process, the computer is caused to calculate the context associated with the learning period and the first point of interest using, from among time series data of the error index and an index related to date and time, at least one of the time series data and the index up to the first point of interest.

15. An accuracy estimating program for causing a computer to execute
an accuracy estimation process of estimating accuracy of a predictive model using an accuracy estimating model that is learned using, as an explanatory variable, all or part of one or more contexts each indicating a feature value representing an operation status of the predictive model at a first point of interest that is a past point in time of interest, a learning period of the predictive model, and a parameter used to learn the predictive model and, as a response variable, an accuracy index in a period after the first point of interest,
wherein in the accuracy estimation process, the computer is caused to calculate the context at a second point of interest that is a point in time after the first point of interest, and apply the calculated context to the accuracy estimating model to estimate the accuracy from the second point of interest onward.

16. The accuracy estimating program according to claim 15, wherein the context is calculated using, from among time series data of an error index calculated based on a prediction result by the predictive model and an actual result and an index related to date and time, at least one of the time series data and the index up to the first point of interest, and is associated with the learning period of the predictive model and the first point of interest.
